(19) United States
(12) Patent Application Publication
(10) Pub. No.: US 2004/0009379 A1
(43) Pub. Date: Jan. 15, 2004

(54) Method and apparatus for processing discharged fuel solution from a hydrogen generator

(76) Inventors: Steven C. Amendola, Ocean, NJ (US); Phillip J. Petillo, Ocean, NJ (US); Stephen C. Petillo, Ocean, NJ (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/193,666

(22) Filed: Jul. 11, 2002

(51) Int. Cl. H01M 8/04

(52) U.S. Cl. 429/17; 429/19

(57) ABSTRACT

The discharged fuel solution remaining after the generation of hydrogen gas from a chemical reaction of a fuel is processed. This processing substantially reduces the liquid content of the discharged fuel thereby substantially reducing both its weight and volume. Such weight and volume reduction provides a corresponding decrease in the costs of storing and transporting the discharged fuel. This technique can be used with virtually any system that generates hydrogen via a hydrolysis process. In the disclosed embodiment, the fuel for generating hydrogen is sodium borohydride and the discharged fuel in the form of a solution or slurry of sodium metaborate is spray dried into a sodium metaborate powder. Advantageously, the present invention may be used with any of a number of techniques that accelerate the process of evaporation.

### FIELD OF THE INVENTION

This invention relates generally to the generation of hydrogen and, more particularly, to a technique for processing the discharged fuel from a system that generates hydrogen from a fuel via a chemical reaction.

### BACKGROUND OF THE INVENTION

It is known that hydrogen can be generated by a chemical reaction. For example, the hydrolysis reactions of many complex metal hydrides, including sodium borohydride (NaBH₄), have been commonly used for the generation of hydrogen gas. The governing chemical reaction for such hydrolysis may be expressed as:

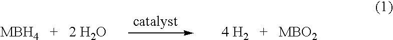

where MBH₄ and MBO₂ respectively represent a metal borohydride and a metal metaborate. As the hydrolysis of sodium borohydride is typically slow at room temperature, heat or a catalyst, e.g., acids, a variety of transition metals, such as ruthenium, cobalt, nickel, or iron, or corresponding metal salts in solution, or metal borides as suspensions, or deposited on inert supports, or as solids, can be used to accelerate the hydrolysis reaction. In addition, the rate of decomposition of the complex metal hydride into hydrogen gas and a metal metaborate is pH dependent, with higher pH values hindering the hydrolysis. Accordingly, solutions of a complex metal hydride, such as sodium borohydride, a stabilizer, such as sodium hydroxide (NaOH), and water are used as the fuel, i.e., the consumable element, from which the hydrogen gas is generated. To expedite the production of the hydrogen gas, the fuel is passed over a catalyst. The output of this process is hydrogen gas and a discharged fuel solution. When the complex metal hydride is sodium borohydride, the discharged fuel is a mixture of sodium metaborate and water; this may be a slurry, a homogeneous solution, or a heterogeneous mixture. Advantageously, the discharged fuel may be “recycled” back into sodium borohydride using well-known processes and reused.

To meet the demands of commercial applications, most hydrogen generating systems also store the fuel and discharged fuel. Such storage gives rise to several disadvantages. One disadvantage arises from the presence of the stabilizer. The function of the stabilizer is to raise the pH value of the fuel solution and, thereby prevent the hydrolysis until the solution contacts the catalyst. As the stabilizer does not participate in any chemical reaction, both the fuel and discharged fuel solutions have a high pH value. Typically, both the fuel and discharged fuel solutions have pH values between 13 and 14. This high pH requires that the transport of both the fuel and discharged fuel solutions comport with governmental regulations that increase the cost of hydrogen generation. The presence of these high pH solutions is also an impediment to the commercialization and public acceptance of the process. Additional costs are imposed by the presence of these high pH solutions as they react with a variety of metals. To avoid these reactions, non-reactive materials, such as stainless or non-reactive plastics, must be used in the hydrogen generation system.

It has been recognized that the widespread deployment of system that generate hydrogen using hydrolysis reactions would be enhanced if the technology could be further developed which address issues associated with the storage and transport of a highly alkaline fuel as well as issues associated with the storage and transport of the discharged fuel from the hydrogen generation system site to a suitable recycling facility. The first part of this problem has been addressed. In a recently developed technique, see, for example, U.S. Patent Application entitled “Method And System For Generating Hydrogen By Dispensing Solid and Liquid Fuel Components”, filed Apr. 2, 2002 and assigned to the present assignee, the fuel for the hydrolysis reaction is generated on an “as needed” basis using solid and liquid fuel components. Advantageously the solid fuel component can take various forms, including granules, powder and pellets. The liquid fuel component includes water. As each fuel component is unable to initiate the hydrolysis reaction without the other and is not highly alkaline, the problems and complexities associated with the storage and transport of a highly alkaline fuel is reduced. The problems associated with the storage and transport of the discharged fuel has not as yet been addressed.

It would be extremely beneficial to the mass deployment of hydrogen generation systems if a methodology could be devised that reduces the costs associated with storing and transport of the discharged fuel.

### SUMMARY OF THE INVENTION

In accordance with the present invention, the discharged fuel solution produced by the generation of hydrogen gas from a chemical reaction of a fuel is processed in a manner that substantially reduces the liquid content of the discharged fuel. Advantageously, this technique can be used with virtually any system that generates hydrogen via a hydrolysis process. It may be used in hydrogen generation systems that use a catalyst as well as with those that do not. It is applicable for use with fuels that include a stabilizer, e.g. sodium hydroxide, as well as with fuels that do not. The form of the fuel is also not important. The fuel may be stored in liquid form or formed at the site of the hydrogen generation system using liquid and solid fuel components.

In a disclosed embodiment, the processing of the discharged fuel utilizes an atomizer or sprayer which receives the discharged fuel and outputs this material in a fine mist so that the liquid content quickly evaporates leaving a “substantially” dry residue. In this regard, it is recognized that sodium metaborate has several hydrate forms which are solid; thus, while water may be evaporated from the solution, it is possible that some will be incorporated into the solid residue. Numerous drying techniques that accelerate the process of evaporation may be used pursuant to the present invention. The removal of all or a substantial portion of the liquid content in the discharged fuel provides a significant reduction in the weight/volume of the discharged fuel and, thereby, a similar reduction in the costs of storing and transporting the discharged fuel.

### BRIEF DESCRIPTION OF THE DRAWINGS

Further objects, features and advantages of the present invention will become apparent from the following written description taken in conjunction with the accompanying figures showing illustrative embodiments of the invention, in which:

FIG. 1 shows one illustrative hydrogen generation system using solid and liquid fuel components and which incorporates the present invention;

FIG. 2 shows another illustrative hydrogen generation system using a liquid fuel and which incorporates the present invention;

FIG. 3 shows an embodiment of the drying apparatus 160 used in the systems of FIGS. 1 and 2; and

FIG. 4 is a flow chart of the sequence of steps for generating hydrogen in accordance with the present invention.

### DETAILED DESCRIPTION

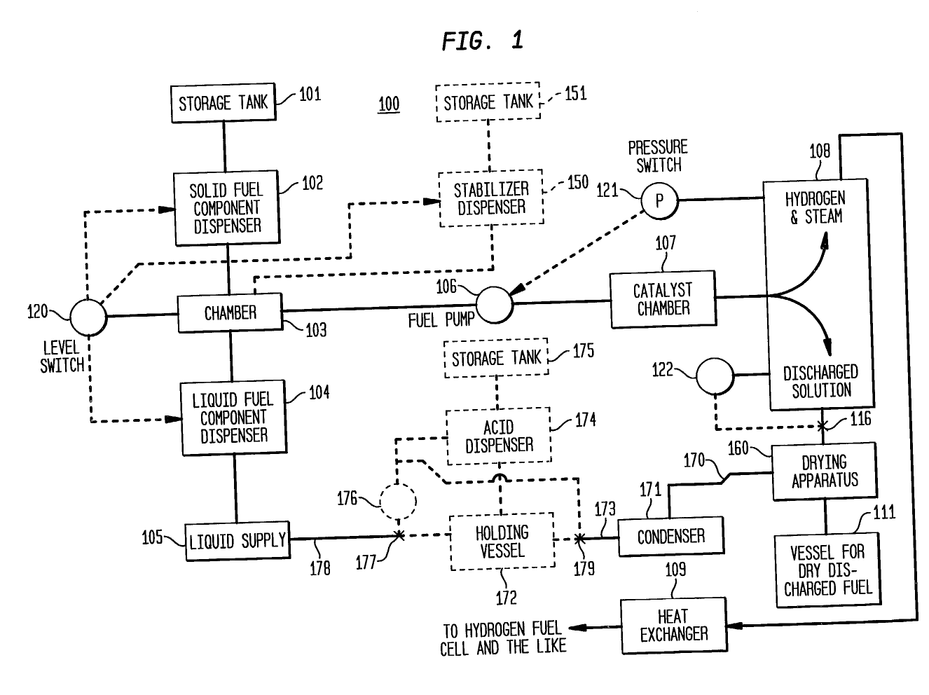

FIG. 1 illustrates an illustrative hydrogen generating system 100 that incorporates the present invention. System 100 includes storage tank 101, solid fuel component dispenser 102, chamber 103, liquid fuel component dispenser 104, liquid fuel component liquid supply 105, fuel pump 106, catalyst chamber 107, separator 108, drying apparatus 160, discharge vessel 111, and heat exchanger 109. The output of heat exchanger 109 supplies hydrogen to a device that consumes this gas, such as a hydrogen fuel cell or hydrogen-burning engine or turbine. Alternatively, the generated hydrogen gas can be coupled to one or more storage vessels. System 100, except for the inclusion of drying apparatus 160, discharge vessel 111 and liquid recycling elements 170-178, is identical to that described in U.S. Patent Application entitled “Method And System For Generating Hydrogen By Dispensing Solid and Liquid Fuel Components”, filed Apr. 2, 2002 and assigned to the present assignee and incorporated herein by reference. As will be described hereinbelow, drying apparatus 160 substantially reduces the liquid content of the discharged fuel and, thereby substantially reduces its weight and volume. This weight and volume reduction advantageously provides a corresponding reduction in the cost of storing and transporting the discharged fuel.

At least one complex metal hydride in a solid form is stored in storage tank 101. This material serves as the solid component of the fuel for generating hydrogen in system 100. The hydrogen generated is in the form of a gas. The complex metal hydrides have the general chemical formula MBH₄. M is an alkali metal selected from Group I (formerly Group 1A) of the periodic table, examples of which include lithium, sodium, or potassium. M may, in some cases, also be ammonium or organic groups. B is an element selected from group 13 (formerly Group IIIA) of the periodic table, examples of which include boron, aluminum, and gallium. H is hydrogen. The complex metal hydride illustratively is sodium borohydride (NaBH₄). Examples of others can be used in accordance with the principles of the invention include, but are not limited to LiBH₄, KBH₄, NH₄BH₄, (CH₃)₄NH₄BH₄, NaAlH₄, NH₄BH₄, KAlH₄, NaGaH₄, LiGaH₄, KGaH₄, and the combinations thereof. The complex metal hydrides in solid form have an extended shelf life as long as they are protected from water and can take various forms, including but not limited to granules, powder and pellets.

The use of sodium borohydride as a fuel component for hydrogen generation is particularly desirable for certain applications. It has been found that the hydrogen gas produced using sodium borohydride is typically of high purity with no carbon-containing impurities, and high humidity. Hydrogen produced by the hydrolysis of any chemical hydride will have similar characteristics. However, no carbon monoxide has been detected in gas streams produced by sodium borohydride. This is noteworthy because most fuels cells, notably PEM and alkaline fuel cells, require high quality hydrogen gas and carbon monoxide will poison the catalyst and eventually corrupt the fuel cell. Other methods of generating hydrogen, such as fuel reforming of hydrocarbons provides a hydrogen gas stream containing carbon monoxide and further processing is then required to remove it. Carbon dioxide is also present in the hydrogen gas stream.

Solid fuel component dispenser 102 provides a predetermined amount of the solid fuel component from storage tank 101 into chamber 103 upon receiving a first control signal. Dispenser 102 is illustratively made of materials that do not chemically react with the solid fuel component, including but not limited to plastics, PVC polymers, and acetal or nylon materials. Dispenser 102, once actuated, may be controlled or otherwise designed to provide a predetermined motion that provides a predetermined amount of the solid fuel component to chamber 103. The operational control of the solid fuel component dispenser can be provided by a variety of arrangements, such as revolving counters, micro switches, and optical shaft encoders. The solid fuel component dispenser itself can also be implemented by a variety of structures. These include a rotational cylinder or a gun clip type dispenser. Other non-limiting examples for the solid fuel component dispenser are commercially available iris valves, air or screw feeds, and equivalent powder-dispensing valves.

Similarly, liquid fuel component dispenser 104 provides a predetermined amount of the liquid fuel component from supply 105 to chamber 103 upon receiving the first control signal. In the disclosed embodiments, the liquid fuel component is water. Other liquid fuel components, such as anti-freeze solvent with water, can be used as well. Dispenser 104 illustratively is a conventional stainless steel solenoid valve. Stainless steel is a desirable valve material when the prepared fuel solution includes a stabilizer, such as sodium hydroxide. If a stabilizer is not dispensed, then brass or plastic can be used as the valve material.

Upon receiving the first control signal, the valve is opened by energizing the solenoid in the valve. Dispenser 104 is illustratively controlled by a timer. The timer provides sufficient duration to energize the solenoid in the valve, so that the valve can discharge predefined volume of liquid to chamber 103. Non-limiting examples, such as flow meters, float switches, or sensors, can also be used to control the liquid fuel component dispenser.

Illustratively, the timers for dispensers 102 and 104 are, but not limited to, a conventional programmable interval timer. Each timer is programmed to the respective predetermined duration, such that when the first control signal is received, the respective dispenser dispenses the respective predetermined amount during that predetermined duration. The timers are set to start the dispensing of the solid and liquid fuel components simultaneously. A delay may be added to either timer, so that the solid fuel component is dispensed first, then the liquid fuel component, or vice versa. It is desirable that the liquid component or other moisture be precluded from entering storage tank 101 as this activates the hydrolysis of the solid fuel component, albeit slowly at room temperature, and thereby shortens the “life” of this fuel component.

Liquid supply 105 is, illustratively, a connection to a water line coupling water from a public water supply or private well. A filled water tank can be used as well. For temperatures below the freezing point of the water, an organic solvent, such as ethylene glycol, can be added to the mixing tank to depress the freezing point of water. Alternatively, the water in liquid supply 105 can be heated.

For some applications, system 100 can be modified to incorporate a third dispenser to provide sodium hydroxide in solid form to the chamber 103. This modification is phantom lines in FIG. 1. As shown, dispenser 150 delivers predetermined measured amounts of stabilizer, such as sodium hydroxide, in solid form from storage tank 150 to chamber 103. Alternatively, the stabilizer in liquid form can be dispensed in combination with the liquid fuel component via dispenser 104. In such case, dispenser 104 would provide an appropriate amount of an aqueous solution of sodium hydroxide of a specified concentration to chamber 103 for the amount of solid fuel component provided by dispenser 102.

Chamber 103 preferably mixes the sold and liquid fuel components to produce a uniform fuel solution, i.e., one having a uniform concentration. Chamber 103 is illustratively equipped with level switch 120. Level switch 120 is illustratively activated by a level sensor, such as a float (not shown), in chamber 103. When the level of the mixed solution drops below a set point, level switch 120 switches its position so as to couple the first control signal to, and thereby activate, the solid fuel component dispenser 102 and the liquid fuel component dispenser 104. Level switch 120 can have another set point that shuts off the dispenser 104 when the level of the solution in chamber 103 reaches a predetermined level. Alternatively, dispenser 104 can be controlled by the movement of a float mechanism (not shown) in chamber 103 that solely controls this dispenser.

Fuel pump 106 pumps the mixed fuel solution to catalyst chamber 107. Fuel pump 106 illustratively is of conventional design and is operated by a conventional motor.

Catalyst chamber 107 includes a hydrogen generation catalyst for activating the hydrolysis reaction of the mixed solution to generate hydrogen. The heat produced may also vaporize some of the water; thus, the generated hydrogen has certain humidity. System 100, however, need not include a catalyst chamber if the pH value of the mixture of solid and liquid fuel components is below 13, but it is oftentimes preferable that such a chamber be incorporated in system 100 to accelerate the generation of hydrogen. The design of such chambers and the various types and dispositions of the catalyst within the chamber are well known. An illustrative embodiment of catalyst chamber 107 is described in United States patent application No. 09/979,363 filed Jan. 7, 2000, for “A System for Hydrogen Generation”, hereby incorporated by reference. Preferably, catalyst chamber 107 also includes a containment system for the catalyst. A containment system, as used herein, includes any physical, chemical, electrical, and/or magnetic means for separating the hydrogen generation catalyst from the reacted mixed solution.

The generated hydrogen (hydrogen and steam) and discharged solution flow into separator 108. The hydrogen and steam exit separator 108 from the vent located at the top of separator 108. The discharged fuel solution, on the other hand, is gravitationally deposited at the bottom of separator 108. In the prior art, the discharged solution is typically drained from drain valve 116 for collection and disposal or recycling back to a liquid fuel solution or a solid fuel component.

Separator 108 is equipped with pressure switch 121 and level switch 122 of conventional design. Switch 121 toggles to a position when the pressure of the generated hydrogen in separator 108 exceeds a predetermined set point. In a number of applications, this pressure set point is between 12 and 15 pounds per square inch (p.s.i.) Of course, depending on the application, other set points may be used. The operation of pressure switch 121 controls fuel pump 106. When the pressure exceeds the predetermined set point, pressure switch 121 turns pump 106 off along with the flow of the mixed fuel solution from chamber 103 to catalyst chamber 107. Both pump 106 and separator 108 are equipped with check valves (not shown), so that the mixed fuel solution, the hydrogen, and the steam do not flow backward. The check valves, illustratively, are made of brass or plastic or other materials suitable for exposure to the mixed fuel, hydrogen and steam or water vapor.

The hydrogen and steam pass through heat exchanger 109 to adjust the relative humidity of the hydrogen. The output of exchanger 109 can be coupled to a device that consumes hydrogen gas in its operation, such as a fuel cell. The fuel cell can be of virtually boundless sizes and shapes. This is a preferred arrangement as the generation of hydrogen by system 100 is on “as needed” basis. That is, the quantity of hydrogen gas generated tracks that required by the hydrogen-consuming device. However, the output of heat exchanger 109 can also be coupled to a tank that stores the hydrogen gas. In either event, the mixed solution in chamber 103 need not be used immediately because the hydrolysis reactions of complex metal hydrides at room temperature (25° C.) is typically slow. It has been observed in an initial test that when NaOH is used, the mixed solution can stay in mixing chamber 103 for two days before being coupled to catalyst chamber 107 without any observable problems.

Level switch 122 controls drain valve 116. Level switch 122 is activated by a level sensor, such as a float (not shown) in separator 108. When the level of the discharged solution in separator 108 exceeds a predetermined set point, level switch 122 switches and in response thereto drain valve 116 opens to discharge the discharged fuel solution into discharge tank 111.

The pressure and level switches can be replaced with sensors for sending their respective readings to a controller. The controller can then control the various devices in system 100, i.e., the dispensers, pumps, valves, etc. An advantage of this arrangement is that the reading that activates any particular device is readily adjustable through a user-friendly interface known to those skilled in the art.

The maximum percentage by weight of the solid fuel component to be mixed with the dispensed amount of liquid fuel component should be not greater than the maximum solubility of the solid fuel component in that amount of liquid fuel component. For example, the maximum solubility of NaBH₄, LiBH₄, and KBH₄ are 35%, 7%, and 19%, respectively. Thus, for NaBH₄, the maximum percentage by weight should be less than 35%. The following table illustratively shows three mixed solutions of NaBH₄ with different predetermined concentrations (% by weight) and the associated predetermined amounts of the NaBH₄ in weight and the water in volume:

| Concentration of | | |
|---|---|---|
| the mixed solution | Weight of | Volume of |
| of NaBH₄ in | solid NaBH₄ | water in |
| weight % | in grams | milliliters |
| 10 | 100 | 900 |
| 20 | 200 | 800 |
| 30 | 300 | 700 |

Fuel pump 106 can be replaced with a valve if system 100 is arranged such that the mixing solution is gravitationally delivered to catalyst chamber 107. The valve is closed when the pressure in separator 108 exceeds the predetermined set point. Also, heat exchanger 109 can be omitted, if the humidity is not a concern for a particular application.

The different parts of system 100 may be connected by brass tubing. The use of stainless or non-reactive plastics is not required because the mixed fuel solution and the discharged fuel solution do not have high pH values. Other materials, such as almost any plastic, e.g., PVC, brass, copper, etc. can be used as well.

Now, in accordance with the present invention, the option of (i) collecting and disposing of the discharged fuel or (ii) recycling this fuel is provided. However, the costs of either of these operations are substantially reduced cost due to the reduction in the volume and weight of the discharged fuel. These benefits are obtained by processing the discharged fuel in a manner that substantially reduces the liquid component of the discharged fuel. Preferably, this processing should remove all of the liquid so that the discharged fuel is in the form of a powder. This powder is sodium metaborate in a mixture of its hydrate forms when the fuel is sodium borohydride. If desired, the liquid removed from the discharged fuel via drying apparatus 160 can be recycled back to liquid supply 105. This is shown in FIG. 1 by the path provided by conduits 170, 173, and 178, condenser 171, holding vessel 172 and solenoid controlled valves 177 and 179. When system 100 includes the use of storage tank 151 and stabilizer dispenser 150, path 170 further includes acid dispenser 174 which dispenses suitable amounts of acid from storage tank 175 to neutralize the amount of stabilizer added to the fuel formed in chamber 103. The amount of acid to be dispensed can be determined by trial and error or by measuring the pH of the liquid in holding vessel 172. If there is no stabilizer in the fuel, then holding vessel 172 along with solenoid controlled valves 177 and 179 can be eliminated from the path between drying apparatus 160 and liquid supply 105.

In the disclosed embodiment, conduit 170 receives the removed liquid in discharged fuel. This liquid is generally in the form of a vapor due to the exothermic nature of the hydrolysis of sodium borohydride. Indeed, in systems that are pressurized by the use of pumps, such as pump 106, the discharged fuel is generally at a temperature above the boiling point of the discharged fuel if it were at atmospheric pressure. Conduit 170 couples the vapors removed from the discharged fuel by drying apparatus 160 and couples the same to condenser 171. This vapor is cooled into a liquid by condenser 171. When system 100 does not utilize a stabilizer, the liquid formed in condenser 171 can be directly coupled back to liquid supply 105. If a stabilizer was present in the fuel, it is possible to neutralize any residual alkaline stabilizer present in the liquid by the addition of an appropriate amount of acid. The elements which accomplish this neutralization are disposed in the path between drying apparatus 160 and liquid supply 105 and are depicted in dotted lines.

As shown, when a stabilizer is added to the fuel, then the contents of condenser 171 flows though conduit 173 and enters holding vessel 172 through open solenoid valve 179. During this time, solenoid valve 177 at the output of holding vessel 172 is closed. The amount of liquid entering holding vessel 172 is monitored by float mechanism 176. Once the level of liquid in holding vessel 172 reaches a predetermined amount, then a control signal is provided by the float mechanism which closes solenoid valve 179 and a short time thereafter causes acid dispenser 174 to dispense an appropriate amount of acid from storage tank 175 into holding vessel 172. The amount of acid dispensed is that sufficient to neutralize the alkaline content of the liquid in holding vessel 172. After this amount of acid is discharged, the contents of holding vessel mechanism may be stirred via any of a variety of stirring mechanisms, e.g. a magnetic stirrer. Solenoid valve 177 then opens permitting the neutralized contents of holding vessel 172 to pass through conduit 178 and into liquid supply 105. After the contents of vessel 172 have been drained, solenoid valve 177 closes and solenoid valve 179 opens and this process of filling and neutralizing the contents of holding vessel 172 is repeated.

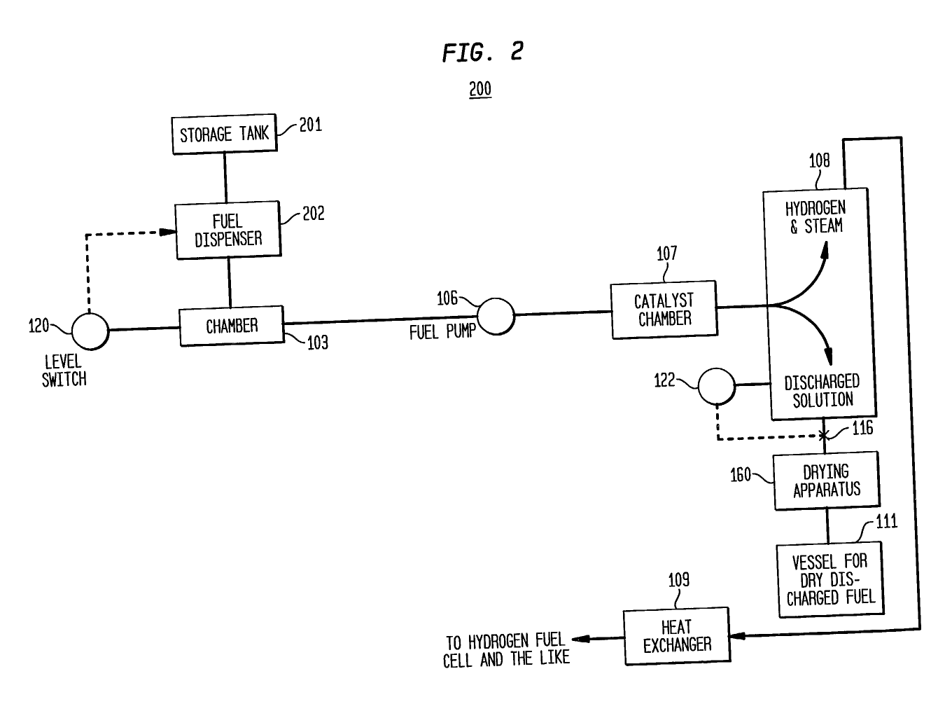

Refer now to FIG. 2 which shows another illustrative hydrogen generating system 200 that incorporates the present invention. System 200 generates hydrogen in a manner similar to that described from system 100 except that the fuel used is a liquid. Accordingly, system 200 uses many of the components of system 100 and such components bear the same reference designation as their counterparts in system 100. System 200 is intended to represent a generic hydrogen generating system of the type that uses a liquid fuel which can be varied in a variety of ways. In particular, system is intended to include those hydrogen generating systems disclosed in U.S. patent application Ser. No. 09/900625, entitled “Portable Hydrogen Generator”, filed Jul. 6, 2001 and assigned to the present assignee and those disclosed in U.S. patent application Ser. No. 09/902899, entitled “Differential Pressure-Driven Borohydride Based Generator”, filed Jul. 11, 2001 and assigned to the present assignee. Both of these applications are hereby incorporated by reference.

In system 200, fuel dispenser 202 dispenses appropriate amounts of the fuel from storage tank 201 to chamber 103. In this illustrative embodiment, the fuel is sodium borohydride and the dispensing process provides this fuel on an “as needed” basis by the operation of level switch 120. Switch 120 actuates fuel dispenser 103 to dispense the fuel when the level of fuel in chamber 103 falls below a predetermined level. Of course, in applications where a “one-shot” dose of fuel is required, the use of storage tank 201 and fuel dispenser 202 can be eliminated.

The fuel in chamber 103 is pumped to catalyst chamber 107 via fuel pump 106. The hydrogen, steam and discharged fuel are then coupled to separator 108 wherein the discharged fuel is separated from the hydrogen and steam, the latter being coupled to heat exchanger 109 wherein the steam is removed. The output of heat exchanger 109, as with system 100, can be provided to a hydrogen fuel call or the like, i.e., any device that consumes hydrogen as an energy source.

The discharged fuel in separator 108 is provided to drying apparatus 160 that substantially reduces the liquid content of the discharged fuel. Since system 200 does not mix liquid and fuel components as is the case in system 100, the recycling of the removed liquid from the discharged fuel is not shown in system 200. However, if desired, the same elements used for recycling the extracted liquid form the discharged fuel can be coupled to drying apparatus 160 in system 200. In this regard, it is noted that when the fuel used in system 200 includes a stabilizer then, for environmental reasons or other reasons, chemically neutralizing the alkaline content in the extracted liquid from the discharged fuel may be desirable. If so, this can be accomplished in the same manner as shown for system 100.

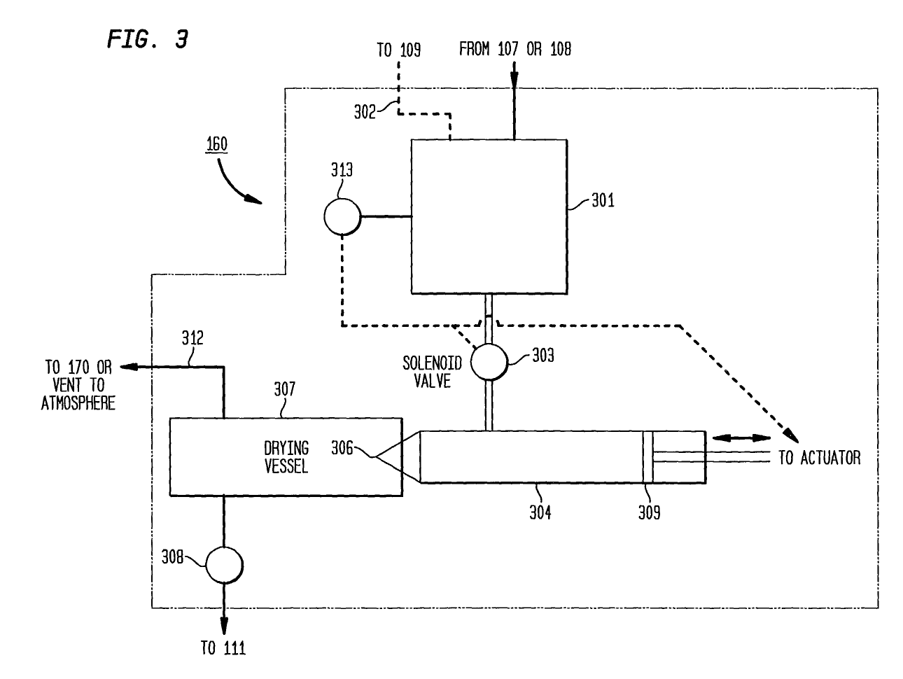

Refer now to FIG. 3 which shows an embodiment of drying apparatus 160. When such apparatus is utilized in system 100 or system 200, the use of separator 108 may be eliminated and replaced by receiving vessel 301. Therefore, in FIG. 3 the input to receiving vessel 301 is shown as being either from separator 108 or directly from catalyst chamber 107. In the latter case, receiving chamber 301 includes an output, shown in dotted lines in FIG. 3 that connects to heat exchanger 109. When a reduction in the moisture content of the hydrogen gas is not a concern, the use of this exchanger can be eliminated and the dotted output path shown in FIG. 3 can be directly connected to a hydrogen fuel cell and the like, or to a suitable storage vessel for hydrogen gas.

In any event, the discharged fuel enters receiving chamber 301 and is accumulated until it reaches a predetermined level. At this point, solenoid valve 303 under the control of level switch 313 opens permitting the discharged fuel to enter cylinder 304. It should be appreciated that due to the exothermic nature of the hydrolysis reaction, the temperature of the discharged fuel solution or slurry in receiving vessel 301 is elevated. Indeed, it is typically above the boiling point of this solution or slurry at atmospheric pressure. The pressure in system 100 and 200 when a pump such as fuel pump 106 is used, is above atmospheric pressure and this prevents the boiling of the discharged fuel. However, in accordance with the embodiment of the drying apparatus 160 shown in FIG. 3, these facts are utilized so as to accelerate the drying of the discharged fuel solution or slurry in a controlled and energy efficient manner.

As solenoid valve 303 opens it provides a signal to cylinder 304 so that piston 309 moves to the right in FIG. 3. This creates a vacuum that accelerates the flow of the discharged fuel solution or slurry into cylinder 304. Actuator 305 controls the movement of piston 309. Actuator 305 is any of a variety of mechanisms including, but not limited to, those driven by electricity and/or gases or liquids.

After cylinder 304 is filled, actuator 305 drives piston 306 to the left in FIG. 3 forcing, under pressure, all or a predetermined portion of the cylinder's contents through nozzle 306. Nozzle 306 has a small aperture, e.g. .020-040 inches, and the discharged fluid passing is broken up into a fine mist that extends outwardly is an expanding pattern into drying vessel 307. Drying vessel is disposed so that its full length can receive the spray pattern emanating from nozzle 306. Since the pressure in vessel 307 is atmospheric pressure, the fine mist of liquid sprayed into vessel 307 quickly evaporates at can exit via outlet 312. As this occurs, the solid contents in this mist are deposited at the bottom of the vessel. This deposit can then be easily removed. Valve 308 facilitates the removal of the solid portion of the discharged fuel.

The performance of nozzle 306 can be enhanced by incorporating an ultrasonic pin in its aperture. This pin vibrates during the drying operation and reduces the likelihood of the nozzle clogging. Such nozzles are commercially available.

While the embodiment of FIG. 3 is believed to possess a number of advantages, other drying mechanisms can be used. Such mechanisms include tumblers, dryers, and spreading or wiping mechanisms that spread the deposited material over a larger surface area so as to accelerate the evaporation process.

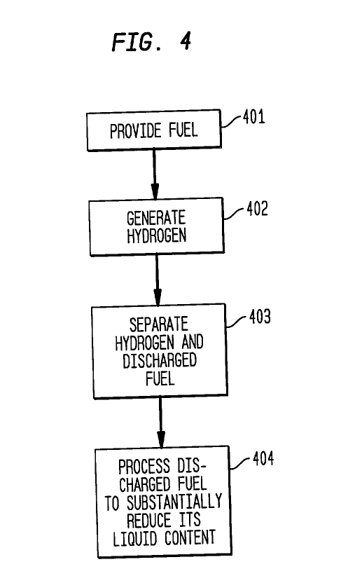

FIG. 4 shows the sequence of operations carried out in accordance with the present invention. At step 401, the fuel is provided from which the hydrogen is generated. This fuel may be a premixed liquid, as in system 200, or may be formed using a solid fuel component and a liquid fuel component, as in system 100. In either case, the fuel, if desired, may include a stabilizer. At step 402, the hydrogen is generated. This generation may include the use of a catalyst or it may not providing the rate of hydrogen generation in the system environment is sufficient to meet system demands and the alkalinity level of the fuel is not so high as to preclude any hydrogen generation at all. If a catalyst is used, then the fuel may be pumped over the catalyst or a supplied using a gravity-fed fuel supply. At step 403, the hydrogen is separated from the discharged fuel. At step 404, the discharged fuel is processed in a manner that substantially reduces its liquid content. If desired, the removed liquid may be recycled and used by the hydrogen generation system. If the fuel includes a stabilizer, then this recycling may include the neutralization of the alkalinity of the extracted liquid.

For the more reactive chemical hydrides (e.g., the aluminum and gallium hydrides), the use of a catalyst to generate hydrogen may not be necessary. In order to utilize the invention with those hydrides, a simplified “one-tank” system should be utilized. Solid (chemical hydride) and liquid (water) fuel components are stored in tanks 101 and 105, respectively, and predetermined amounts of these are directly supplied to chamber 301 (shown in FIG. 3 and being a part of the drying apparatus 160), in lieu of chamber 103. The hydrogen and steam generated by the hydrolysis reaction exit chamber from a vent at the top of the chamber. The discharged fuel solution is gravitationally deposited on the bottom of the chamber, and carried to cylinder 304 as described above.

The following examples provide the results of several tests that were conducted in accordance with the present invention.

### EXAMPLE 1

In this example, one liter of aqueous sodium borohydride fuel (25 wt-% sodium borohydride and 3 wt-% sodium hydroxide) was pumped through a catalyst chamber 107. The pressure in the system was maintained between 25 and 45 p.s.i.

No heat was added and all necessary energy was captured from the exothermic hydrolysis reaction shown in equation 1. The corresponding pressure maintained the temperature at approximately 110° C.). Pressurizing the system provided a superheated solution to the spray-drying nozzle so that the fine mist of discharged fuel was already above the boiling point when exposed to the lower atmospheric pressure.

The fuel was pumped through the combined system in 16 minutes. The steam was vented and the solids collected. Approximately 510 grams of steam were produced and 490 grams of solid material was collected. (If 100% of the water were removed, 460 grams of solid sodium metaborate and sodium hydroxide would have been collected). The pH of the recovered material was 14.

The residue was recovered as a liquid that solidified on cooling in behavior typical of hydrated salts.

### EXAMPLE 2

In this example, one liter of aqueous sodium borohydride fuel (25 wt-% sodium borohydride) was pumped through catalyst chamber 107. The pressure in the system was maintained between 25 and 45 p.s.i.

For testing purposes, the fuel was pumped through the combined system in 14 minutes. The steam was vented and the solids collected.

Approximately 540 grams of steam were produced and 460 grams of solid material was collected. The residues solidified upon cooling. The pH of the recovered material was 10.5.

The foregoing description has been presented to enable those skilled in the art to more clearly understand and practice the instant invention. It should not be considered as limitations upon the scope of the invention, but as merely being illustrative and representative of several embodiments of the invention. Numerous modifications and alternative embodiments of the invention will be apparent to those skilled in the art in view of the foregoing description.

What is claimed:

1. A system for generating hydrogen comprising
a chamber for holding a fuel solution, said fuel solution generating hydrogen and a discharged fuel solution via a chemical reaction,
first outlet and second outlets for respectively receiving said generated hydrogen, and said discharged fuel solution; and
an element for receiving said discharged fuel solution and removing substantial amounts of the liquid therein.

2. The system of claim 1 further including a catalyst chamber for receiving said fuel solution from said chamber, said catalyst enhancing the rate at which hydrogen and discharged fuel is generated from said fuel solution.

3. The system of 1 further including a pump for pumping said fuel solution from said chamber to said catalyst chamber.

4. The system of claim 1 wherein said fuel solution is formed from a solid fuel component and a liquid fuel component and said system further includes a sold fuel component dispenser for respectively providing predetermined amounts of a solid fuel component and a liquid fuel component to said chamber, each dispenser being operative in response to a predetermined condition.

5. The system of claim 4 further including a stabilizer dispenser for providing a certain amount of stabilizer to said chamber in response to said predetermined condition.

6. The system of claim 1 including a dispenser for providing a predetermined amount of said fuel solution to said chamber in response to a predetermined condition.

7. The system of claim 1 wherein the generated hydrogen includes moisture and said system further including apparatus, coupled to said first outlet, for reducing the moisture in the generated hydrogen.

8. The system of claim 1 wherein said element facilitates evaporation of said discharged fuel solution.

9. The system of claim 1 wherein said element includes a nozzle for outputting said discharged fuel solution as a spray.

10. The system of claim 9 wherein said nozzle receives said discharged fuel solution under pressure.

11. The system of claim 10 wherein said discharged fuel solution under pressure is provided by supplying said discharged fuel solution to a cylinder and then forcing this solution through said nozzle via movement of a piston disposed within said cylinder.

12. The system of claim 9 further including a vessel for receiving the spray provided by said nozzle.

13. Apparatus for use with a discharged fuel solution, said discharged fuel solution being generated by a chemical reaction of a fuel solution that also generates hydrogen, said apparatus comprising
an input for receiving said discharged fuel solution; and
an element for removing substantial amounts of the liquid content of said discharged fuel solution.

14. The apparatus of claim 13 wherein said element includes a nozzle for outputting said discharged fuel solution as a fine spray.

15. The apparatus of claim 14 wherein said apparatus further includes a device for supplying said discharged fuel solution to said nozzle under pressure.

16. A method of processing a discharged fuel solution generated by a chemical reaction of a fuel solution that also generates hydrogen, said method comprising the steps of
receiving said discharged fuel solution; and
removing substantial amounts of the liquid content of said discharged fuel by in a manner that expedites the evaporation process.

17. A method of generating hydrogen comprising the steps of
providing a fuel solution capable of generating hydrogen along with a discharged fuel and coupling said generated hydrogen to an output; and
receiving said discharged fuel solution and processing the same as so to remove substantial amounts of the liquid content of said discharged fuel solution, said processing being one that expedites the evaporation process.
